(19) United States
(12) Patent Application Publication
(10) Pub. No.: US 2008/0131140 A1
(43) Pub. Date: Jun. 5, 2008

(54) Method for communication link connection using visible light communication

(75) Inventors: Dong-Jae Shin, Seoul (KR); Dae-Kwang Jung, Suwon-si (KR); Hong-Seok Shin, Suwon-si (KR); Kyung-Woo Lee, Yongin-si (KR); Sung-Bum Park, Suwon-si (KR); Yoo-Jeong Hyun, Seongnam-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/998,286

(22) Filed: Nov. 29, 2007

(30) Foreign Application Priority Data
Nov. 30, 2006 (KR) 120151 /2006

(51) Int. Cl. H04B 10/00

(52) U.S. Cl. 398/172

(57) ABSTRACT

A method for communication link connection in a data transmission between devices using visible light communication (VLC) that can provide a visible indication prior to establishing a communication link between the devices. The method includes activating a VLC mode by a first VLC apparatus in order to transmit the data; scanning other apparatuses to establish a communication link with a second VLC apparatus; requesting a communication link to the second VLC apparatus in order to transmit the data; and receiving a response, indicating whether data can be received from the second VLC apparatus, and establishing communication link connection. A user can easily recognize the visual indication before the establishment of the communication link, providing an opportunity for the user to arrange the apparatus for optimal communication distance/angle from another device, and for a status of the communication.

### CLAIM OF PRIORITY

This application claims the benefit under 35 U.S.C. §119(a) from an application entitled “Method for Communication Link Connection Using Visible Light Communication,” filed in the Korean Intellectual Property Office on Nov. 30, 2006 and assigned Serial No. 2006-120151, the contents of which are hereby incorporated by reference in its entirety.

### BACKGROUND OF THE INVENTION

1. Field of the Invention

The present invention relates to a method for communication link connection using visible light communication (VLC) by which a user can easily recognize communication links. More particularly, the present invention relates to a VLC method in which a user can recognize a period prior to the establishment of the communication link, wherein a user can directly confirm a status of the communication currently being performed between VLC devices.

2. Description of the Related Art

There have been recent improvements in the luminance efficiency of Light Emitting Diodes (LEDs), as well as a reduction in price through improved manufacturing techniques and an increased economy of scale. Accordingly, LEDs have become increasingly popular in general lighting markets, which include markets for fluorescent lamps and glow lamps, as well as specific lighting markets which includeuse as a display in portable devices, monitors, in automobiles, traffic lights, billboards, etc.

In particular, a white LED has already become a the preferred means for constructing a glow lamp due to the luminance efficiency, and products superior to a fluorescent lamp have emerged. In addition, VLC has become increasing popular due to various factors (e.g. the exhaustion of RF bandwidth, confusion possibilities between several wireless communication technologies, an increasing demand for communication security, advent of an ultra-high speed ubiquitous communication environment based on 4G wireless technologies, etc), as there has been an increased interest in optical wireless technologies that are complementary to RF technologies. Therefore, research in the field of visible light wireless communication employing a visible light LED is now in progress by many enterprises and laboratories.

In a case of portable devices, such as a mobile telephones, PDAs and small-sized home appliances, such as a digital camera, and an MP3 player, research has been already conducted for providing a peripheral interface that performs inter-device communication using an Infrared Data Association (IrDA) module equipped therein, and related manufactures have been developed and commercialized. Unlike Radio Frequency (RF) communication, such as Bluetooth, Zigbee, etc., infrared ray wireless communication has advantages in that it can achieve reliable security and lower power consumption without confusion between devices.

FIG. 1 is a view illustrating a construction of a wireless communication system using an infrared ray according to the prior art.

As shown in FIG. 1, the wireless communication system 100 using an infrared ray is mainly used to establish Peer to Peer (P to P) communication between a first and second infrared ray communication apparatuses 101, 102 respectively. In order to perform infrared ray communication, the infrared ray communication apparatuses 101, 102 are equipped with respective infrared ray transceivers 103, 104 including a transmitter and a receiver. Herein, the transmitter includes a Light Emitting Diode (LED) and an optical modulator, and the receiver includes a Photo Diode (PD) and a demodulator. The infrared ray transceivers 103 and 104 are arranged to face each other, so as to establish an infrared ray connection 110 there between.

However, for such conventional infrared ray communication, both of the terminal must each be newly equipped with one of the infrared ray transceivers 103, 104, which causes inconvenience. Moreover, it takes a significant amount of time to transmit contents at a speed in the area of Mbps through the conventional infrared ray communication system. Also, the infrared ray connection 110 can be established only when a transmitter faces a receiver. For example, beam divergence of a transmitter appointed by current standard organizations is 30 degrees. Beyond 30 degrees, it is typically impossible to normally establish communication through infrared rays.

FIG. 2 is a flow diagram illustrating a process for data transmission in a wireless communication system using an infrared ray according to the prior art. In this diagram a first and second infrared ray communication apparatuses establish communication with each other, followed by a data exchange, and then a disconnection when the communication there between is complete.

Moreover, when data is transmitted in the conventional infrared ray wireless communication system, a number of sub-steps typically occur during the communication process. For example, when a data packet is sent from a first infrared ray communication apparatus to a second infrared ray communication apparatus, the following processes 1 to 7 are performed, which includes: 1. Irda Activation; 2. Device Discovery; 3. Negotiation; 4. Connection; 5. Data Transfer; 6. Disconnection; and 7. Irda DeActivation.

In data transmission using the processes 1 to 7 as described above, when a user arranges infrared ray communication links for link establishment, the first infrared ray communication apparatus 101 outputs infrared rays with a discontinuous time delay, so as to scan if there is an infrared ray wireless interface apparatus (i.e. a second infrared ray communication apparatus 102) in the vicinity of the first infrared ray communication apparatus 101. The discontinuously output infrared rays as described above have no influence on arrangement of communication links by a user in that there is no feedback provided regarding the status of the communication, and the user arranges the communication links by roughly adjusting the infrared ray communication apparatus toward the area where the second infrared ray communication link is located.

According to the conventional infrared ray communication, infrared rays are not transmitted prior to the establishment of the communication link, meaning, for example, that there is no type of pilot signal or per-communication scanning that occurs by either of the devices to ascertain if there are other devices within range. Furthermore, a user cannot recognize the link state even if links are disconnected during scanning of infrared ray communication devices, link connection after the scanning, or data transmission between two apparatuses 101 and 102.

Therefore, due to the above-described shortcomings of IR communication apparatuses, a scheme using visible light is expected to take the initiative in future local area network systems. There also has been proposed a method of performing communication between devices by using a visible light LED, which has been greatly developed in view of technologies and prices, instead of the infrared ray IrDA module. When a visible light LED is used for peripheral interface communication, a user can confirm communication paths through his/her eyes and thus can visually identify communication security. Moreover, the use of the visible light LED achieves easy arrangement of communication paths, which reduces a divergence angle of light as compared with existing infrared ray communication, and thus can achieve high-speed communication and/or a low-power operation compared with conventional systems.

### SUMMARY OF THE INVENTION

Accordingly, the present invention has been made in part to solve at least some of the above-mentioned problems occurring in the prior art. The present invention provides a method for providing a communication link connection, by which, prior to the communication links being established between apparatuses performing wireless visible light communication (VLC) through a visible light LED, a user can easily recognize a state indicating that the communication links are about to be established.

The present invention also provides a method for providing a communication link connection, by which an advantage of the method is that a user can directly confirm a state indicting that communication is currently in process between visible light communication apparatuses.

In accordance with one exemplary aspect of the present invention, there is provided a method for establishing a communication link connection in data transmission using visible light communication, the method including the steps of: activating a visible light communication mode by a first visible light communication apparatus in order to transmit the data; outputting visible light signals with continuous or discontinuous time delay before establishment of the communication link so that a user can arrange links which are to be connected with a second visible light communication apparatus; requesting a communication link to the second visible light communication apparatus in order to transmit the data; and receiving a response, indicating if the data can be received, from the second visible light communication apparatus, and establishing a communication link connection.

In accordance with another exemplary aspect of the present invention, there is provided a method for establishing a communication link connection in data transmission using visible light communication, the method including the steps of: activating a visible light communication mode by a first visible light communication apparatus in order to transmit the data; outputting visible light signals with continuous or discontinuous time delay so that optionally a user can arrange links with a second visible light communication apparatus before establishment of the communication link; requesting a communication link to the second visible light communication apparatus in order to transmit the data; outputting predetermined visible light signals with continuous or discontinuous time delay by the second visible light communication apparatus receiving the visible light signals; and receiving a response, indicating if data can be received, from the second visible light communication apparatus, and establishing the communication link connection.

In accordance with another exemplary aspect of the present invention, there is provided a method for establishing a communication link connection in data transmission using visible light communication, the method including the steps of: activating a visible light communication mode by a first visible light communication apparatus in order to transmit the data; requesting a communication link by outputting visible signals with a discontinuous time delay before establishment of the communication link so that a user can arrange links with a second visible light communication apparatus; and establishing communication link connection by transmitting predetermined visible light signals as a response, indicating if data can be received, from the second visible light communication apparatus, with a discontinuous time delay.

### BRIEF DESCRIPTION OF THE DRAWINGS

The above and other exemplary aspects, features and advantages of the present invention will be more apparent from the following detailed description taken in conjunction with the accompanying drawings, in which:

FIG. 1 is a view illustrating a wireless communication system using infrared rays according to the prior art;

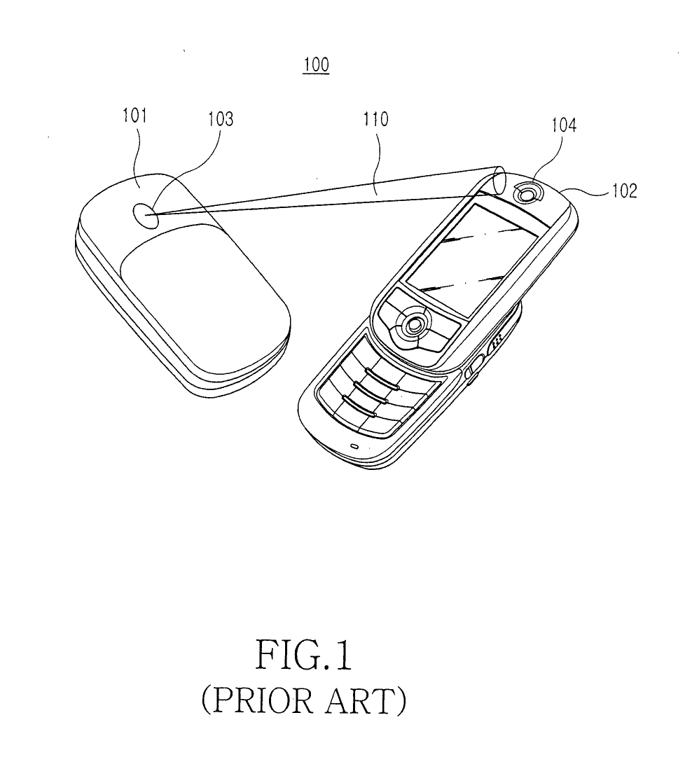

FIG. 2 is a flow diagram illustrating a process for data transmission in a wireless communication system using infrared rays according to the prior art;

FIG. 3 is a block diagram illustrating a visible light communication apparatus according to a first exemplary embodiment of the present invention;

FIG. 4 is a flow diagram illustrating a method for communication link connection through visible light communication according to a first exemplary embodiment of the present invention;

FIG. 5 is a flow diagram illustrating a process for communication link connection between visible light communication apparatuses according to a first exemplary embodiment of the present invention;

FIG. 6 is a flow diagram illustrating a method for communication link connection through visible light communication according to a second exemplary embodiment of the present invention;

FIG. 7 is a flow diagram illustrating a process for communication link connection between visible light communication apparatuses according to the exemplary second embodiment of the present invention;

FIG. 8 is a flow diagram illustrating a method for communication link connection through visible light communication according to a third exemplary embodiment of the present invention;

FIG. 9 is a flow diagram illustrating a process for communication link connection between visible light communication apparatuses according to the third exemplary embodiment of the present invention;

FIG. 10 is a flow diagram illustrating a method for communication link connection through visible light communication according to a fourth exemplary embodiment of the present invention; and

FIG. 11 is a flow diagram illustrating a process for communication link connection between visible light communication apparatuses according to the fourth exemplary embodiment of the present invention.

### DETAILED DESCRIPTION OF THE INVENTION

Hereinafter, embodiments of the present invention will be described with reference to the accompanying drawings, which have been provided for illustrative purposes, and do not limit the present invention to the examples shown and described. In the following description, the same elements will be designated by the same reference numerals although they are shown in different drawings. Further, in the following description, a person of ordinary skill in the art understands that a detailed description of known functions and configurations incorporated herein may be omitted when such inclusion may obscure the appreciation of the subject matter of the present invention with a description of such known functions and configurations.

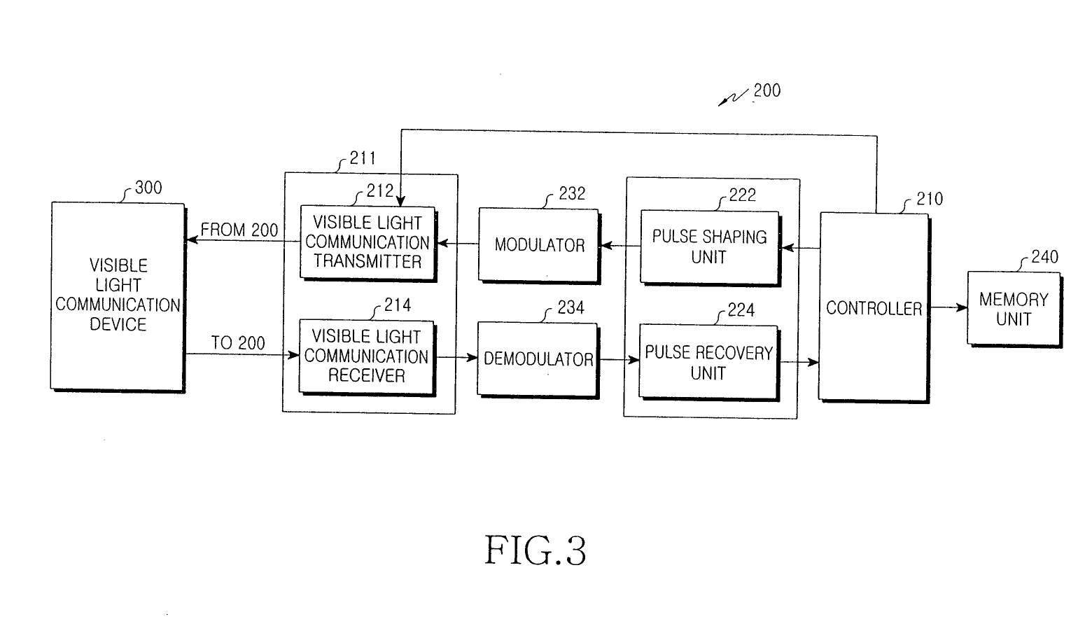

FIG. 3 is a block diagram illustrating a construction of a visible light communication apparatus according to a first exemplary embodiment of the present invention.

As shown in FIG. 3, a visible light communication apparatus 200 according to an exemplary embodiment of the present invention typically includes a controller 210, and a transceiver 211 comprising a visible light communication transmitter 212 and a visible light communication receiver 214, a pulse shaping unit 222 and a pulse recovery unit 224, a modulator 232, and a demodulator 234.

The controller 210 performs the overall control operation of the visible light communication apparatus 200. Particularly, when a visible light communication mode is performed, the controller 210 controls the visible light communication transmitter 212 to provide an output of predetermined visible light signals having wavelengths of 350 nm to 700 nm according to continuous or discontinuous time delay (less than 0.1 second), before the establishment of the communication link.

In all of the exemplary embodiments, a person of ordinary skill in the art understands that the communication link can be established without an action on the part of the user. Therefore, the user positioning or arranging a position of the VLC device is optional and not required to practice the invention. The VLC communication link may be established after providing a visual indication without confirmation by the user.

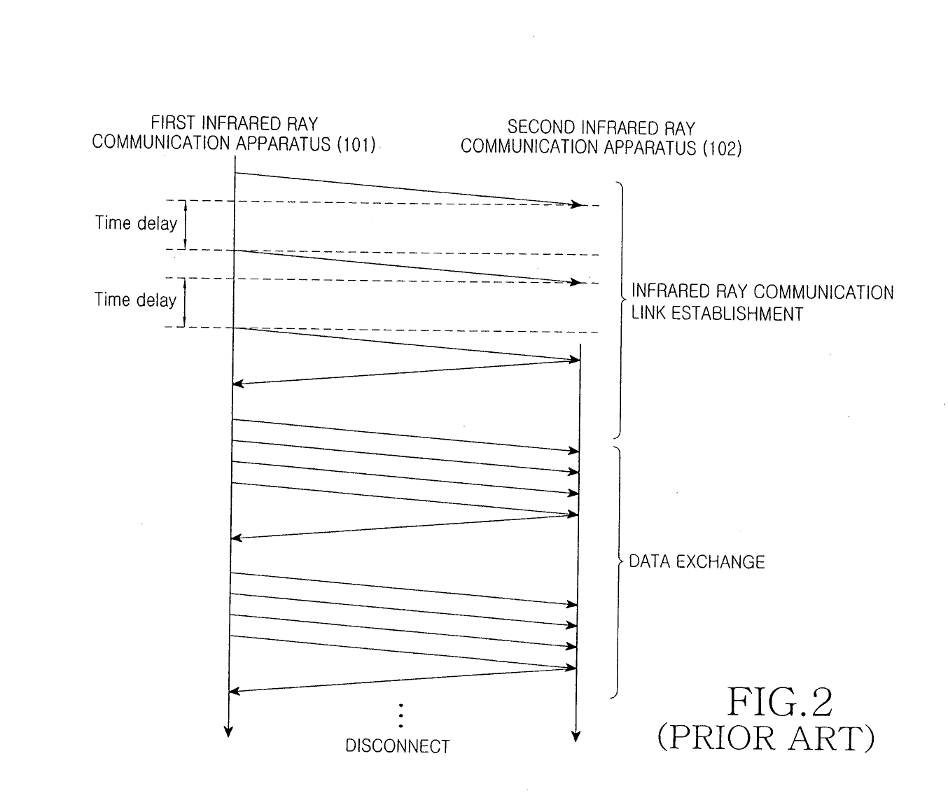

Still referring to FIG. 2 the controller 210 also controls the visible light communication transmitter 212 to transmit an ACK message and data to another visible light communication apparatus 300, when the data communication is currently being performed. Furthermore, data received through visible light communication is stored in a memory unit 240.

Hereinafter, an operation for transmitting data in a visible light communication apparatus 200 will be described with reference to the construction of FIG. 3.

First, upon receiving instructions from the controller 210 to transmit data, the pulse shaping unit 222 generates pulse signals corresponding to transmission data, and outputs the resultant signals to the modulator 232. Then, the modulator 232 modulates the input pulse signals into signals suitable for visible light communication, and outputs the modulated signals to the visible light communication transmitter 212.

In this case, the visible light communication transmitter 212 outputs corresponding visible light signals according to control signals of the controller 210. Such a visible light communication transmitter 212 may include a Laser Diode (LD), a Light Emitting Diode (LED), or an array of an LD and an LED, as a light source with wavelength of 350 nm to 700 nm.

Hereinafter, an operation for receiving data in the visible light communication apparatus 200 that is sent from the communication apparatus 300 will be described with reference to the construction of FIG. 3.

When visible light signals transmitted from another visible light communication apparatus (device) 300 are input to the visible light communication receiver 214, the visible light communication receiver 214 converts the input visible light signals into electrical signals, and outputs the converted signals. In this case, the visible light communication receiver 214 may include a Photo Diode (PD) for converting light, input from the outside, into electrical signals.

Meanwhile, the demodulator 234 demodulates the input electrical signals into data suitable for visible light communication, and outputs the demodulated signals to the pulse recovery unit 224. Then, the pulse recovery unit 224 recovers pulse signals from the input electrical signals, and outputs the resultant signals to the controller 210.

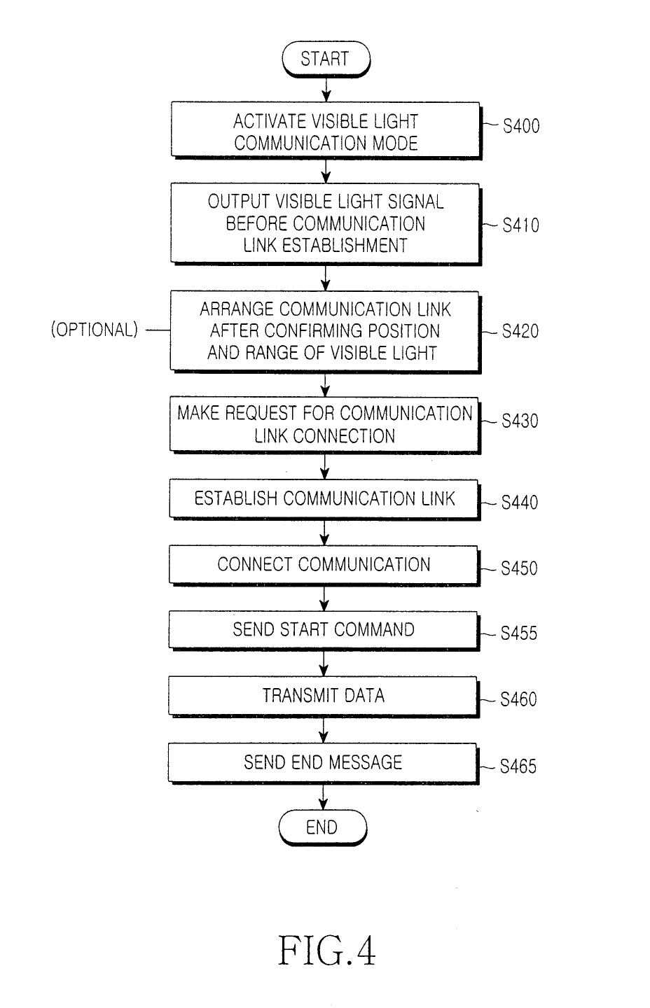

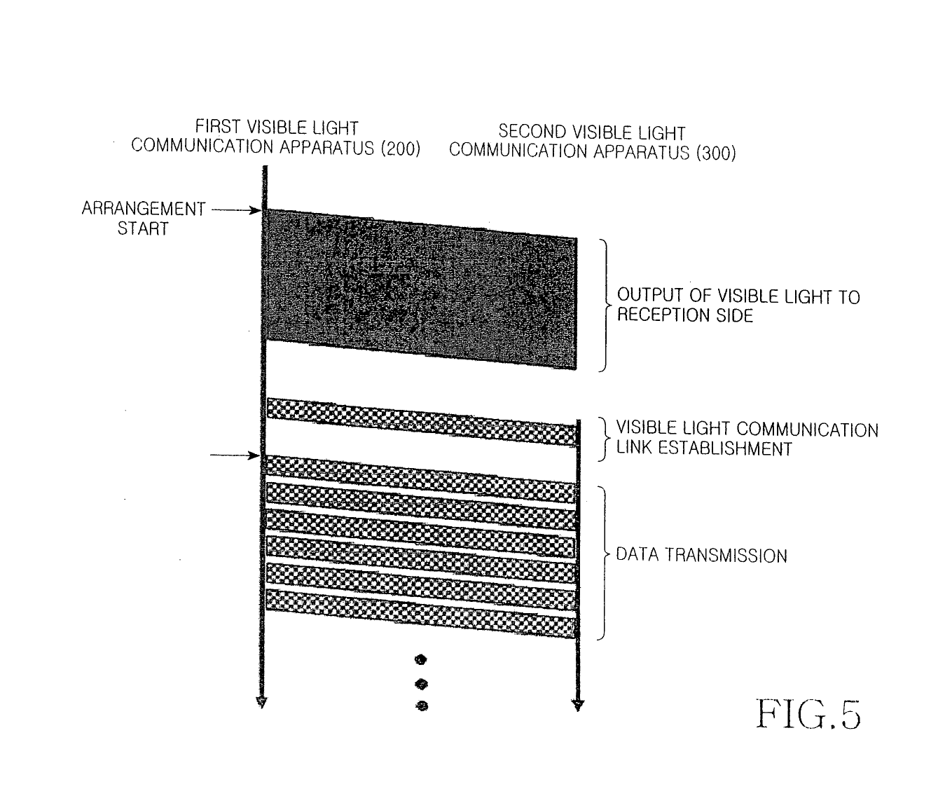

Hereinafter, a process for data transmission between visible light communication apparatuses having the construction as illustrated in FIGS. 4 and 5 will be described.

FIG. 4 is a flow chart illustrating a method for providing a communication link connection through visible light communication according to a first exemplary embodiment of the present invention. FIG. 5 is a flow diagram illustrating a process for establishing a communication link connection between visible light communication apparatuses according to a first exemplary embodiment of the present invention.

As shown in FIGS. 4 and 5, when a first visible light communication apparatus 200 starts to establish a communication link to transmit data to a second visible light communication apparatus 300, the first visible light communication apparatus 200 applies a power source to the visible light communication transmitter 212 (shown in FIG. 3) and activates a visible light communication mode in order to transmit data (step S400).

The visible light communication apparatus 200 outputs visible light signals having no data according to a user key operation, and scans another visible light communication apparatus 300 (i.e. reception side) to which the data is to be received. In other words, in order to arrange communication links with the second visible light communication apparatus 300, the visible light communication apparatus 200 typically initially outputs predetermined visible light signals according to a continuous or a discontinuous time delay (less than 0.1 second) so that a user can visually recognize that communication links (step S410) are desired/about to be established.

Optionally, the user visually confirms a position and a range of visible light, and arranges the first visible light communication apparatus 200 in a position to transmit/receive light signals from apparatus 300 in order to establish communication links with the second visible light communication apparatus 300 (step S420).

As such, after the arrangement with the second visible light communication apparatus 300 is completed, the first visible light communication apparatus 200 outputs visible light signals, requesting communication links for data transmission, to the second visible light communication apparatus 300 (step S430).

The second visible light communication apparatus 300 having received the request for establishment of the communication links by the first visible light communication apparatus 200 transmits a response, indicating whether data can be received, to the first visible light communication apparatus 200.

Typically, after communication apparatus 200 sends the response to communication apparatus 300, the first visible light communication apparatus 200 establishes the communication link with the second visible light communication apparatus 300 (step S440). The first visible light communication apparatus 200 also determines an optimal version communication scheme selected from among a variety of communication schemes applicable to the communication between the first visible light communication apparatus 200 and the second visible light communication apparatus 300. Then, the first visible light communication apparatus 200 is interconnected with the second visible light communication apparatus 300 according to the determined communication scheme (step S450).

Still referring to FIG. 4, when the first visible light communication apparatus 200 is interconnected with the second visible light communication apparatus 300, the first visible light communication apparatus 200 transmits a data transmission start command message to the second visible light communication apparatus 300 (step S455).

After transmitting the data transmission start command message, at step S460, the first visible light communication apparatus 200 sequentially transmits multiple data signals to the second visible light communication apparatus 300. In this case, the second visible light communication apparatus 300 is allowed to continually maintain the connection with the first visible light communication apparatus 200 by the data transmission start command message, and it continually receives multiple data signals without the disconnecting the links with the first visible light communication apparatus 200. According to the present invention, the start command (step S455) and the transmit data step (step S460) may occur in sequential transmissions or as part of the same transmission.

After the first visible light communication apparatus 200 transmits all of the transmission data through the above-described processes, the first visible light communication apparatus 200 generates a data transmission end command message, and transmits the generated data transmission end command message to the second visible light communication apparatus 300. Then, the second visible light communication apparatus 300 disconnects the links with the first visible light communication apparatus 200 according to the data transmission end command message (step S465). The data and the end message may be sent sequentially, or as part of the same transmission.

After the first visible light communication apparatus 200 transmits the data transmission end command message to the second visible light communication apparatus 300, it disconnects the links with the second visible light communication apparatus 300, and releases the visible light communication mode.

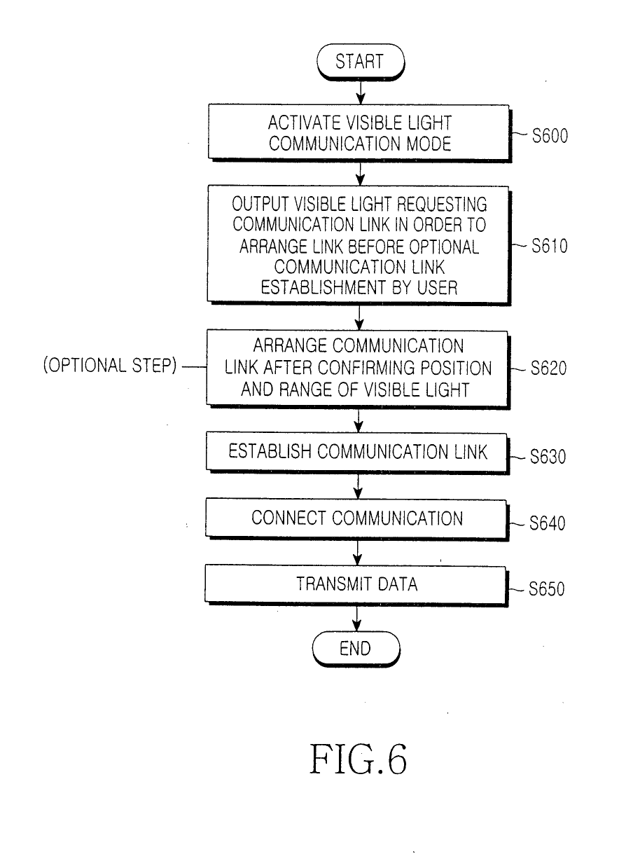

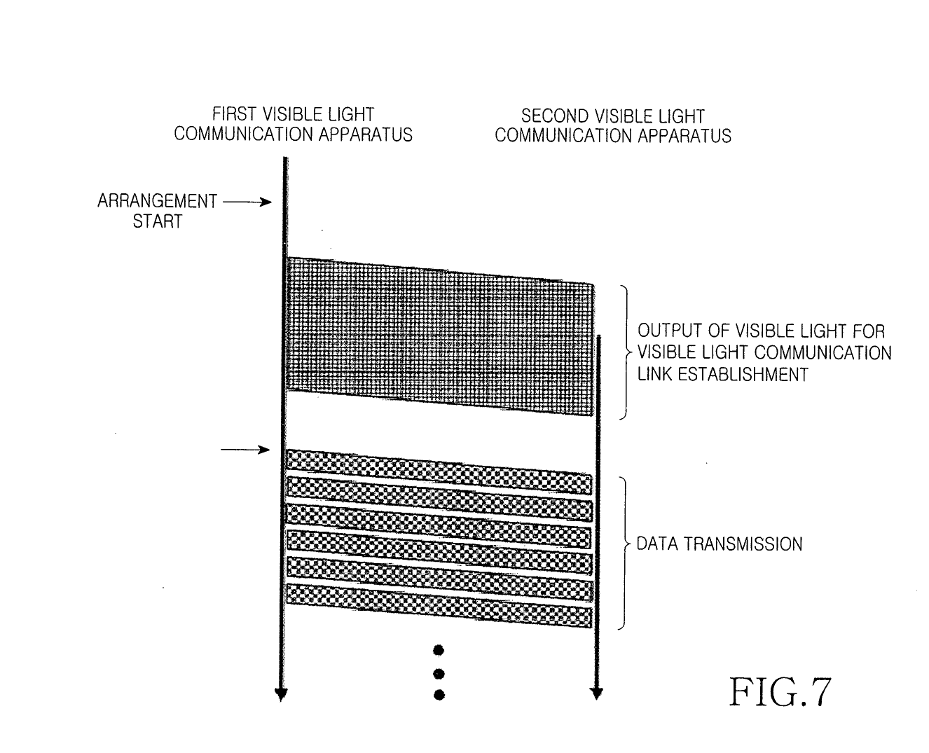

FIG. 6 is a flowchart illustrating a method for providing a communication link connection through visible light communication according to a second exemplary embodiment of the present invention. FIG. 7 is a flow diagram illustrating a process for communication link connection between visible light communication apparatuses, according to the second exemplary embodiment of the present invention.

As shown in the examples in FIGS. 6 and 7, when the first visible light communication apparatus 200 transmits data to the second visible light communication apparatus 300, the first visible light communication apparatus 200 typically applies a power source to a visible light communication transmitter 212 and activates the visible light communication mode in order to transmit data (step S600).

In order to transmit the data to the second visible light communication apparatus 300 (i.e. reception side) to which the data is to be received, the first visible light communication apparatus 200 outputs predetermined visible light signals, requesting communication links, typically with a discontinuous time delay (less than about 0.1 second) according to a user key operation, so that a user can visually recognize links before establishment of the communication link (step S610).

Then, the user visually confirms a position and a range of visible light, and arranges the first visible light communication apparatus 200 in order to establish communication links with the second visible light communication apparatus 300 (step S620).

Still referring to FIG. 6, at step (S630), the second visible light communication apparatus 300 having received the request for establishment of the communication links by the first visible light communication apparatus 200 transmits a response, indicating if data can be received, to the first visible light communication apparatus 200. Then, the first visible light communication apparatus 200 establishes the communication links with the second visible light communication apparatus 300 (step S630).

The first visible light communication apparatus 200 also determines an optimal version communication scheme from among a variety of communication schemes applicable to the communication between the first visible light communication apparatus 200 and the second visible light communication apparatus 300. Then, the first visible light communication apparatus 200 is interconnected with the second visible light communication apparatus 300 according to the determined communication scheme (step S640).

When the first visible light communication apparatus 200 is interconnected with the second visible light communication apparatus 300, the first visible light communication apparatus 200 transmits data to the second visible light communication apparatus 300 (step S650).

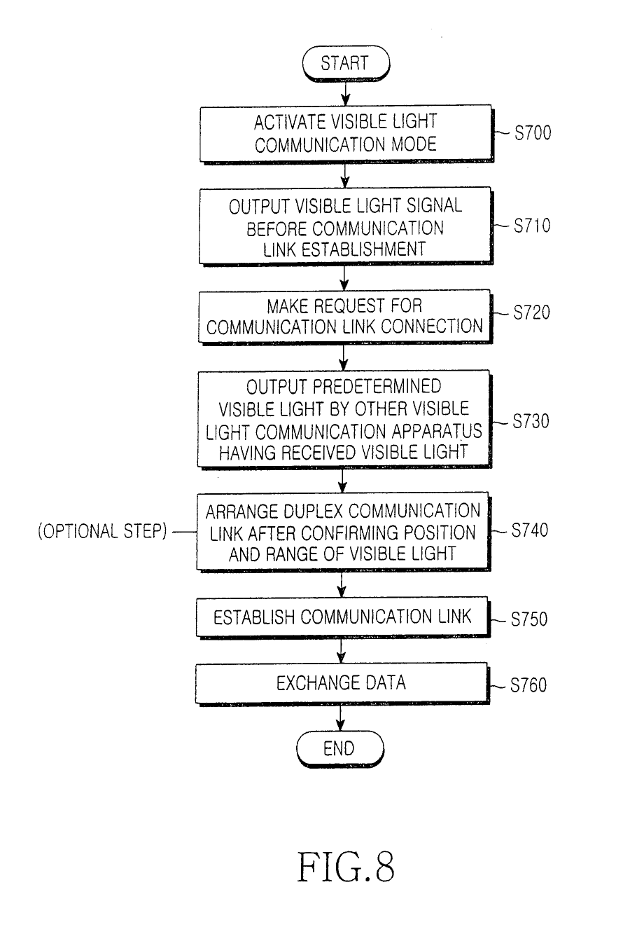

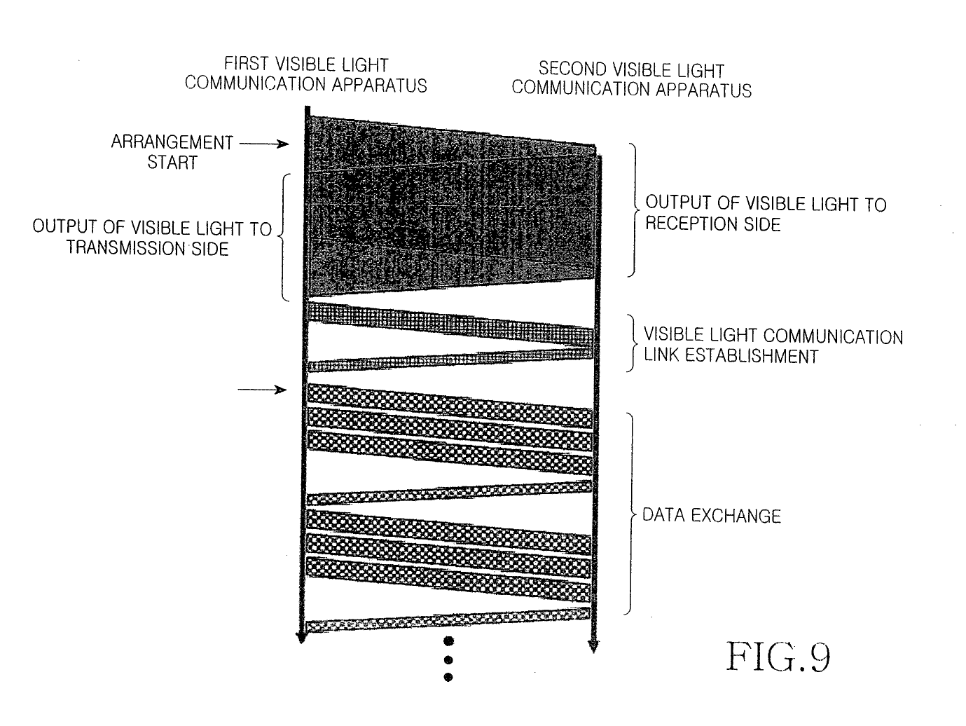

FIG. 8 is a flowchart illustrating a method for providing a communication link connection through visible light communication according to a third exemplary embodiment of the present invention. FIG. 9 is a flow diagram illustrating a process for communication link connection between visible light communication apparatuses, according to the third exemplary embodiment of the present invention.

As shown in FIGS. 8 and 9, when the first visible light communication apparatus 200 transmits data to the second visible light communication apparatus 300, the first visible light communication apparatus 200 applies a power source to the visible light communication transmitter 212 (an example of which is shown in FIG. 3) and activates the visible light communication mode in order to transmit data (step S700).

The visible light communication apparatus 200 outputs visible light signals having no data according to a user key operation, and scans other visible light communication apparatus 300 (i.e. reception side) to which data is to be received. That is, in order to arrange communication links with the second visible light communication apparatus 300, the visible light communication apparatus 200 outputs predetermined visible light signals according to a continuous or a discontinuous time delay (less than 0.1 second) so that a user can visually recognize communication links (step S710).

As such, after completing the scanning of the second visible light communication apparatus 300, the first visible light communication apparatus 200 outputs visible light signals, requesting communication links for data transmission, to the second visible light communication apparatus 300 (step S720).

The second visible light communication apparatus 300 having the visible light signals received from the first visible light communication apparatus 200 then outputs the predetermined visible light signals for the communication link arrangement with a continuous or a discontinuous time delay (less than 0.1 second) so that a user can visually recognize communication links (step S730).

Then, the user visually confirms a position and a range of visible light, and arranges the first visible light communication apparatus 200 to establish duplex communication links with the second visible light communication apparatus 300 (step S740).

The second visible light communication apparatus 300 having received the request for establishment of the communication links by the first visible light communication apparatus 200 transmits a response, indicating whether data can be received, to the first visible light communication apparatus 200. Then, the communication links arranged by the user is established between the first visible light communication apparatus 200 and the second visible light communication apparatus 300 (step S750).

Then, the first visible light communication apparatus 200 is interconnected with the second visible light communication apparatus 300 through the established communication links, so that they can exchange data (step S760).

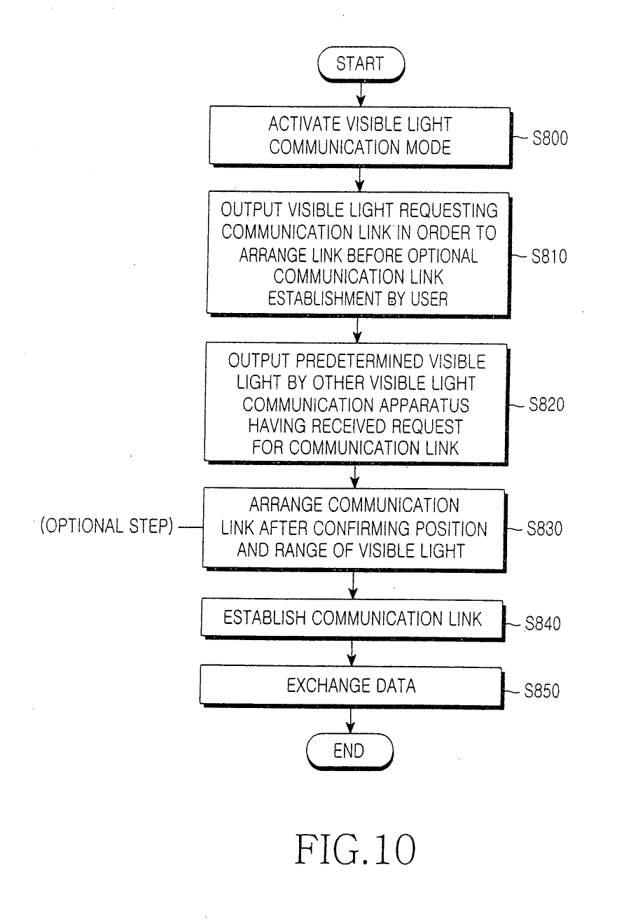

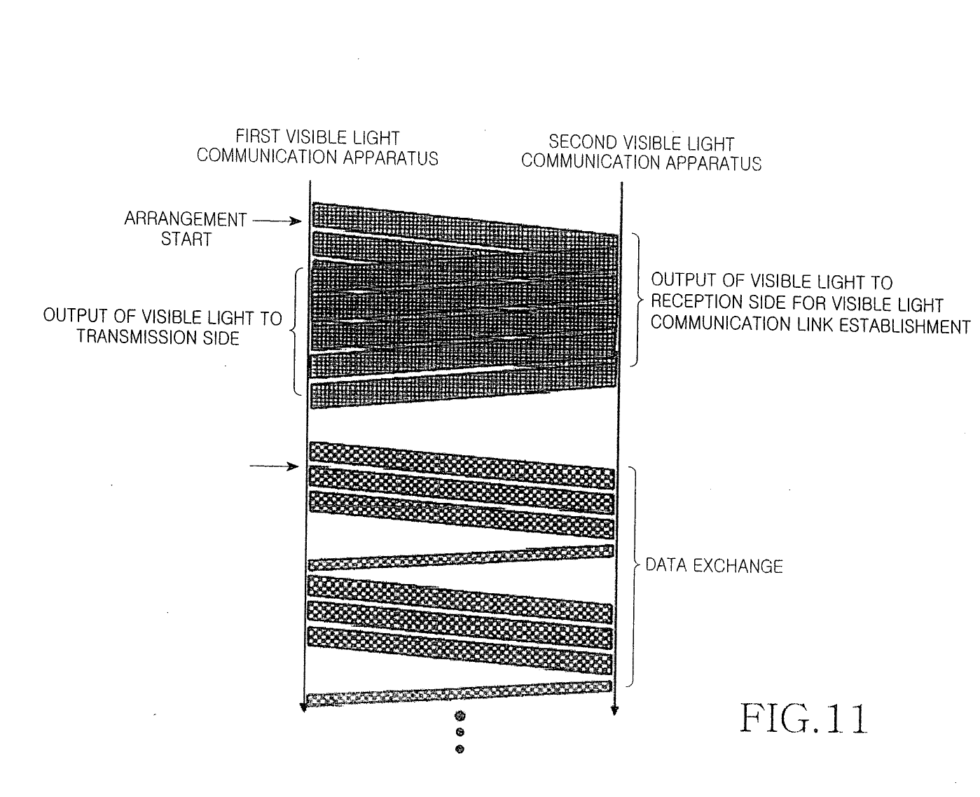

FIG. 10 is a flowchart illustrating a method for communication link connection through visible light communication according to a fourth exemplary embodiment of the present invention. FIG. 11 is a flow diagram illustrating a process for communication link connection between visible light communication apparatuses, according to the fourth embodiment of the present invention.

As shown in the examples in FIGS. 10 and 11, when the first visible light communication apparatus 200 transmits data to the second visible light communication apparatus 300, the first visible light communication apparatus 200 applies a power source to the visible light communication transmitter 212, and activates the visible light communication mode in order to transmit data (step S800).

In order to transmit the data to the second visible light communication apparatus 300 (i.e. reception side) to which the data is to be received, the first visible light communication apparatus 200 outputs predetermined visible light signals, requesting communication links, with a discontinuous time delay (less than 0.1 second) according to a user key operation, so that a user can visually_recognize links before establishment of the communication link (step S810).

The second visible light communication apparatus 300 having received the request for establishment of the communication links by the first visible light communication apparatus 200 outputs the predetermined visible signals as a response, indicating if data can be received, with discontinuous time delay (less than 0.1 second), so that a user can visually recognize communication links and arrange communication links (step S820).

Then, the user visually confirms a position and a range of visible light, and arranges the first visible light communication apparatus 200 to typically establish duplex communication links with the second visible light communication apparatus 300 (step S830).

The communication link arranged by the user is established between the first visible light communication apparatus 200 and the second visible light communication apparatus 300 (step S840). Then, the first visible light communication apparatus 200 is interconnected with the second visible light communication apparatus 300 through the established communication links, so that they can exchange data (step S850).

Therefore, when a visible light LED is used to establish interface communication with a peripheral device, it is easy to connect communication link connection between the visible light communication apparatuses 200 and 300. In addition, a user can directly confirm the communication link connection and visually recognize if the communication links are established.

In an apparatus for performing wireless visible communication through a visible light LED according to the present invention, it is easy to connect communication links prior to the establishment of the communication link. Moreover, according to the present invention, a user can visually recognize a sate in which communication is currently being performed, so that communication according to the present invention can be more popular than the conventional infrared ray communication.

According to exemplary embodiments of the present invention, it is possible to achieve a method for communication link connection through visible light communication. While the invention has been shown and described with reference to certain exemplary embodiments thereof, it will be understood by those skilled in the art that various changes in form and details may be made therein without departing from the spirit of the invention and the scope of the appended claims. For example, the step of the user confirming a range and position of the first apparatus 200 prior to transmission of data is convenient, but is optional. If the apparatuses are within range and position of each other for transmission/reception, the communication will occur without user intervention unless the apparatuses are not positioned within range of each other, or something is blocking the path there between, or there are external light sources causing interference, etc. of one or more of the apparatuses. The ability of the user to be forewarned of an impending communication, to provide the opportunity to arrange the apparatus/apparatuses to reduce the possibility of an error, and to receive a visual signal indicating the transmission has stopped, are advantages heretofore unknown.

Furthermore, the visible light signals output by the apparatus while scanning, establishing, or maintaining a communication link may be separate and apart from an indication of a status of the VLC devices. For example, there can be a separate indicator to show when a VLC mode is beginning, a link is being established, or communication is taking place. The indicator can be visual, such as light that turns on or changes color, or blinks at the same or different rates, an audible tone, a vibratory tone, or an indicator, such as an icon, on a display screen of the device. These indicators can also signal when a communication is occurring, ended, etc. and may differentiate between all of the possible variations.

What is claimed is:

1. A method for communication link connection in data transmission using visible light communication (VLC), the method comprising the steps of:
(1) activating a visible light communication mode by a first VLC apparatus in order to transmit the data;
(2) outputting one or more visible light signals with a continuous or a discontinuous time delay prior to establishment of the communication link;
(3) requesting a communication link with a second VLC apparatus; and
(4) receiving a response from the second VLC apparatus, indicating whether the data can be received from the second VLC apparatus, and establishing a communication link connection.

2. The method according to claim 1, wherein, in step (2), includes scanning by the first VLC apparatus for the second visible light communication apparatus by outputting said one or more visible light signals without data to establish a communication link.

3. The method according to claim 2, further comprising providing a visual indication apart from said one or more visible light signals which identifies that the first VLC apparatus is in process of establishing the communication link.

4. The method according to claim 2, further comprising providing an audible indication apart from said one or more visible light signals which identifies that the first VLC apparatus is in process of establishing the communication link.

5. The method according to claim 2, further comprising providing a vibratory indication apart from said one or more visible light signals which identifies that the first VLC apparatus is in process of establishing the communication link.

6. The method according to claim 2, further comprising said one or more visible light signals including an indication on a display screen which identifies that the first VLC apparatus is in process of establishing the communication link.

7. The method according to claim 1, wherein in step (4) establishing the communication link connection is performed automatically when the response indicates that data can be received.

8. The method according to claim 1, wherein step (2) includes a sub-step of confirming and arranging a position and a range of visible light, so as to establish communication links.

9. The method as claimed in claim 1, further comprising the steps of:
(5) transmitting a data transmission start command message, reporting data transmission initiation from the first visible light communication apparatus to the second visible light communication apparatus in order to transmit the data;
(6) transmitting the data to the second visible light communication apparatus; and
(7) transmitting a data transmission end command message reporting data transmission termination after the data transmission completion.

10. The method as claimed in claim 9, further comprising a step of disconnecting the links with the second visible light communication apparatus and releasing the visible light communication mode, after the data transmission end command message is transmitted.

11. The method according to claim 9, further comprising providing a visual indication apart from said one or more visible light signals which identifies that the first VLC apparatus has established the communication link.

12. The method according to claim 9, further comprising providing an audible indication apart from said one or more visible light signals which identifies that the first VLC apparatus has established the communication link.

13. The method according to claim 2, further comprising said one or more visible light signals including an indication on the display screen which identifies that the first VLC apparatus has established the communication link.

14. The method according to claim 11, further comprising providing an visual indication apart from said one or more visible light signals which identifies that data is being transmitted/received over the established communication link.

15. The method according to claim 13, further comprising said one or more visible light signals includes an indication the display screen which identifies that data is being transmitted/received over the established communication link.

16. The method according to claim 1, wherein in step (4) establishing the communication link connection is performed automatically when the response indicates that data can be received.

17. The method as claimed in claim 9, wherein the second visible light communication apparatus receives the data transmission start command message, and continually maintaining a connection state according to the data transmission start command message.

18. The method as claimed in claim 9, wherein the second visible light communication apparatus receives the data transmission end command message, and disconnects the links according to the data transmission end command message.

19. The method as claimed in claim 1, wherein the visible light signals have wavelengths selected from a group of wavelengths consisting of 350 nm to 700 nm.

20. A method for communication link connection in data transmission using visible light communication, the method comprising the steps of:
(1) activating a visible light communication mode by a first visible light communication apparatus in order to transmit the data;
(2) outputting visible light signals with continuous or discontinuous time delay with a second visible light communication apparatus prior to establishment of the communication link;
(3) requesting a communication link to the second visible light communication apparatus in order to transmit the data;
(4) outputting predetermined visible light signals with continuous or discontinuous time delay by the second visible light communication apparatus receiving the visible light signals; and
(5) receiving a response, indicating if data can be received, from the second visible light communication apparatus, and establishing the communication link connection.

21. The method as claimed in claim 20, wherein, in step (2), the first visible light communication apparatus scans the second visible light communication apparatus by outputting visible light signal without data to establish a communication link.

22. The method as claimed in claim 20, wherein step (4) comprises a sub-step of confirming and arranging a position and a range of visible light to establish communication links.

23. The method as claimed in claim 20, wherein the visible light signals have wavelengths selected from a group of wavelength consisting of 350 nm to 700 nm.
